(19) United States
(12) Patent Application Publication
(10) Pub. No.: US 2026/0122409 A1
(43) Pub. Date: Apr. 30, 2026

(54) UNIFIED MICROPHONE AND LOUDSPEAKER TO REDUCE ACOUSTIC COUPLING

(71) Applicant: Biamp Systems, LLC, Beaverton, OR (US)

(72) Inventors: Aaron Anthony Lutzo, Bridgeport, PA (US); Samarth Behura, Hillsboro, OR (US); Charles Emory Hughes, II, Gastonia, NC (US); Jason E. Damori, Lake Oswego, OR (US)

(73) Assignee: Biamp Systems, LLC, Beaverton, OR (US)

(21) Appl. No.: 18/929,885

(22) Filed: Oct. 29, 2024

(51) Int. Cl. H04R 1/28; H04R 1/02; H04R 1/08

(52) U.S. Cl. CPC H04R 1/2873; H04R 1/025; H04R 1/028; H04R 1/08; H04R 2201/021

(57) ABSTRACT

The example embodiments are directed to a unified loudspeaker and microphone apparatus which reduce acoustic coupling between the loudspeaker and microphone. In one example, the apparatus may include a housing, a loudspeaker integrated into the housing, a microphone integrated into the housing, and an air gap disposed in between the loudspeaker and the microphone. The loudspeaker, the microphone, and the air gap may be arranged along a common plane within the housing.

### BACKGROUND

When a microphone is placed nearby a loudspeaker, it can sense the radiated output signal from the loudspeaker. If the source of the loudspeaker signal and the destination of the microphone signal are also coupled, the result is a feedback loop. In a live sound scenario, this is called feedback. In a telecommunications scenario, this effect is referred to as echo. The far end of a call receives its own content looped back. The amount of coupling loss between the loudspeaker and microphone can be quantified by an echo return loss (ERL) metric. Echo cancellers are designed to enhance this ERL, providing additional echo reduction observed by the far end, ensuring high-quality voice communication. Providing for high amounts of ERL reduces the requirements of an echo canceller for a given total echo reduction target, providing possible benefits like improved overall performance, reduced energy consumption, and lower computational cost and complexity. Because of the proximity of the microphone and loudspeaker in speakerphones, they provide an especially challenging environment, with typically very low ERL requiring the echo canceller to do more to provide an adequate experience for the far end.

### SUMMARY

One example embodiment provides an apparatus that includes a housing, a loudspeaker integrated into the housing, a microphone integrated into the housing, and an air gap disposed in between the loudspeaker and the microphone, wherein the loudspeaker, the microphone, and the air gap are arranged along a common plane within the housing.

Another example embodiment provides an apparatus that includes a substrate, a loudspeaker integrated into the substrate, an air gap inside an outer perimeter of the substrate, and a microphone disposed inside the air gap.

Another example embodiment provides another apparatus that includes a substrate, a microphone integrated into the substrate, a loudspeaker integrated into the substrate and inside of the microphone, and an air gap disposed between an outer perimeter of the loudspeaker and an inner perimeter of the microphone.

### BRIEF DESCRIPTION OF THE DRAWINGS

FIG. 1A is a diagram illustrating a front-perspective view of a speakerphone apparatus that includes a loudspeaker diaphragm and a microphone according to example embodiments.

FIG. 1B is a diagram illustrating a rear-perspective view of the speakerphone apparatus according to example embodiments.

FIG. 1C is a diagram illustrating a side-perspective view of the speakerphone apparatus according to example embodiments.

FIG. 2A is a diagram illustrating a speakerphone apparatus according to other example embodiments.

FIG. 2B is a diagram illustrating a side-perspective view of the speakerphone apparatus according to other example embodiments.

FIGS. 3A-3B are diagrams illustrating sound pressure level measurements at different points along the speakerphone apparatus according to example embodiments.

FIG. 4 is a diagram illustrating a dipole directivity sound radiation graph of a speakerphone apparatus according to example embodiments.

### DETAILED DESCRIPTION

It is to be understood that although this disclosure includes a detailed description of the example embodiments, implementation of the teachings recited herein is not limited to the example embodiments. Rather, embodiments of the instant solution are capable of being implemented with additional features and functions not expressly mentioned herein but which will be understood to one of ordinary skill in the art.

The example embodiments are directed to a speakerphone apparatus (e.g., unified loudspeaker and microphone) that is constructed in such a manner to maximize echo return loss based on placement of the microphone in a null area of the sound radiation pattern of the loudspeaker. For example, the microphone can be placed at a 90° angle with respect to an “on axis” direction of the sound radiation from the loudspeaker. The apparatus leverages the dipole characteristics of the loudspeaker by placing the microphone at a location where the pressure of one polarity from the front of a diaphragm sum to zero with the pressure of the opposite polarity from the back of the diaphragm, thereby attenuating the sound in the direction of the placement of the microphone.

Dipole directivity is characterized by a “figure eight” shaped coverage pattern. The strongest direct sound comes from an “on axis” direction that is normal (perpendicular) to the device's diaphragm, and (ideally) there is a perfect cancellation at 90 degrees off axis from that direction. This is due to the pressure wave from the front of the device's diaphragm combining with the pressure wave from the back of the device's diaphragm, which is of opposite polarity compared to the pressure wave from the front of the diaphragm. By placing the microphone at the 90 degree off-axis position relative to the diaphragm, it is inside the directivity null. As a result, the sound output by the diaphragm is attenuated in the off-axis direction toward the microphone. A shock mount system may be used to isolate the microphone from the vibrations of the loudspeaker.

Traditionally, a dipole is realized by a pistonic diaphragm that allows the front and rear pressure waves to combine. This is opposed to a baffle whereby the rear pressure wave never combines with the front (such as sealed enclosures, ported enclosures, or infinite baffles).

In the example embodiments, the loudspeaker portion of the speakerphone may be designed such that there is a center section that is unconstrained, instead of the outer perimeter being unconstrained. This results in an acoustic null in this center section of the loudspeaker apparatus. There are different possible placements of the microphone with respect to the loudspeaker such that the pressure waves radiated by the loudspeaker combine to cancel out the echo at the microphone location.

For example, a distributed mode loudspeaker (DML) is not bound to a geometry that must facilitate an electromagnetic motor structure. As such, a hole can be cut in the center of the DML and the outer edges fixed to accomplish a first design. The hole/gap may be large enough for the null to form, but small enough that it does not significantly reduce the output of the loudspeaker. The microphone may be placed in the center of the hole/gap where the null is located. Another variation of the loudspeaker is that the edges of the DML may be left unconstrained and a gap is left open around the diaphragm between it and the frame in which it is mounted. The acoustic null thus forms around the perimeter of the diaphragm. In this example, the microphone can be placed outside of the parameter of the diaphragm where the acoustic null is formed. In either case, placing the microphone in the gap to take advantage of the acoustic null that is created is advantageous for increasing the ERL of speakerphone performance.

In the example embodiments, an apparatus may include a housing, a loudspeaker integrated into the housing, a microphone integrated into the housing, and an air gap disposed in between the loudspeaker and the microphone. In this example, the loudspeaker, the microphone, and the air gap may be arranged along a common plane within the housing.

In additional embodiments, an apparatus may include a substrate, a loudspeaker integrated into the substrate, an air gap inside an outer perimeter of the substrate, and a microphone disposed inside the air gap.

In additional embodiments, an apparatus may include a substrate, a microphone integrated into the substrate, a loudspeaker integrated into the substrate and inside of the microphone, and an air gap disposed between an outer perimeter of the loudspeaker and an inner perimeter of the microphone.

In some embodiments, the housing or the substrate may include a tile such as a ceiling tile. In some embodiments, the air gap may be disposed inside an outer perimeter of the loudspeaker and the microphone may be integrated into the air gap. In some embodiments, the loudspeaker may include a square shape, and the air gap that includes a circular shape disposed inside an outer perimeter of the square shape of the loudspeaker. In some embodiments, the air gap may be disposed outside of an outer perimeter of the loudspeaker and the microphone is integrated outside of the outer perimeter of the loudspeaker. In some embodiments, the air gap may create an acoustic null within the housing.

In some embodiments, the apparatus may further include a securing mechanism that is attached to the housing, the microphone, and the loudspeaker. In this example, the securing mechanism may secure the microphone with respect to the loudspeaker such that the air gap exists between the microphone and the loudspeaker. In some embodiments, the securing mechanism may include at least one slat that is coupled to the housing, the microphone, and the the loudspeaker. The coupling may be performed using glue, a screw, a nail, a staple, adhesive, or the like. As another example, the microphone 110 may be fixed to the securing mechanism 150 via a threaded rod, etc. which cause the microphone 110 to be rigidly secured to the securing mechanism 150.

In the example embodiments, a loudspeaker may be referred to as a diaphragm. The diaphragm of a loudspeaker is a thin, semi-rigid membrane that converts mechanical vibrations into sound. The diaphragm can be made of various materials including paper, plastic, fabric, lightweight metal, or the like. In some embodiments, the loudspeaker may be a distributed mode loudspeaker (DML) which includes an exciter that causes a panel to vibrate.

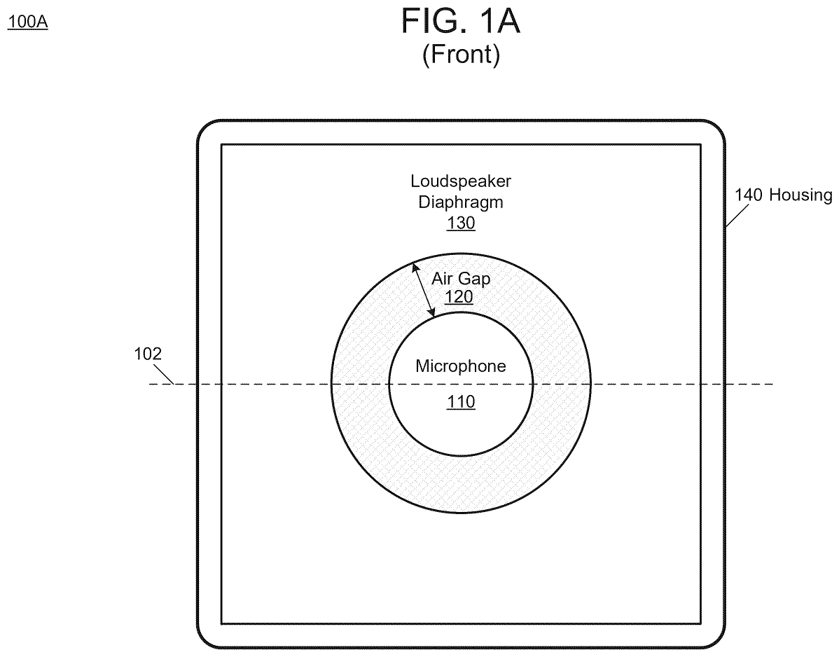

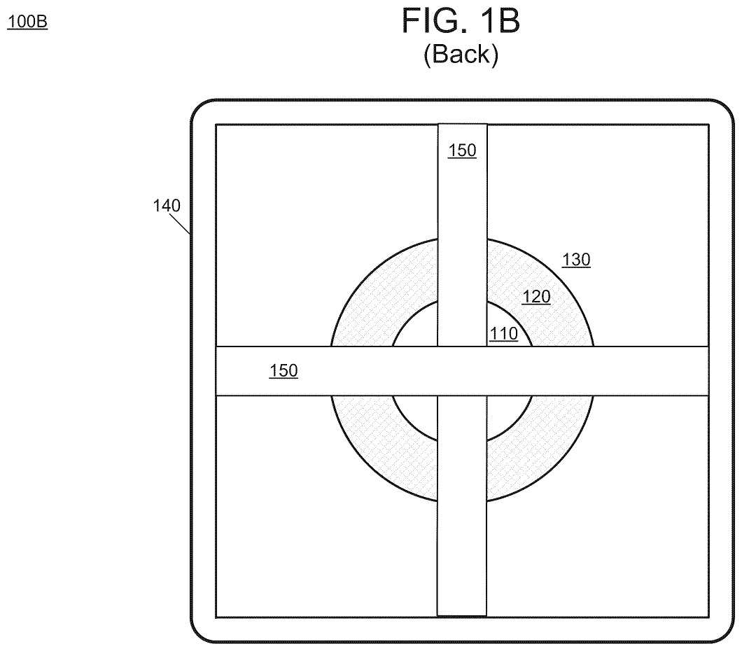

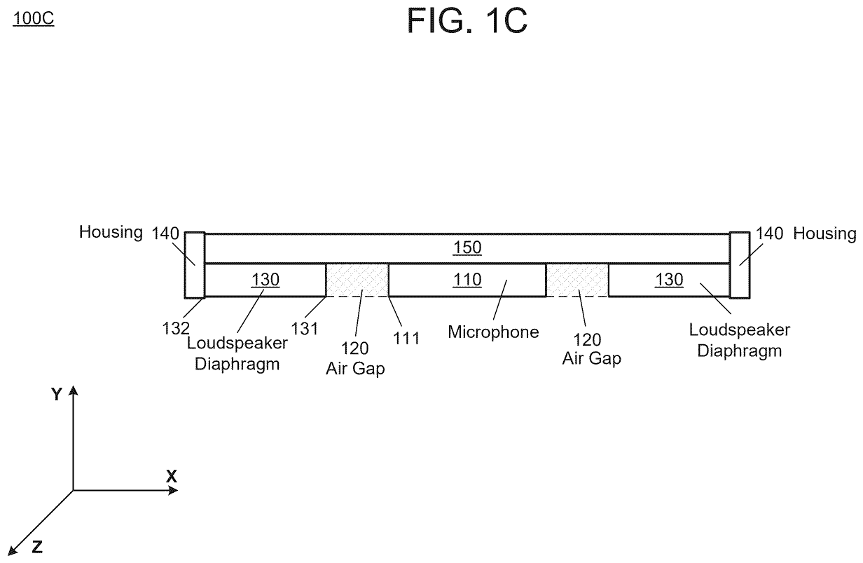

FIG. 1A illustrates a front-perspective view 100A of a speakerphone apparatus that includes a diaphragm 130 (e.g., a loudspeaker diaphragm) and a microphone 110 according to example embodiments. Referring to FIG. 1A, the diaphragm 130 may include a diaphragm of a loudspeaker that emits sounds, such as sound from a phone call, teleconference, or other medium. In the example of FIG. 1A, the diaphragm 130 has a square shape, however, embodiments are not limited thereto. As another example, the diaphragm 130 may be a rectangular shape, a circular shape, or the like.

According to various embodiments, a hole may be cut or otherwise a center of the diaphragm may be removed thereby creating an air gap 120 within the middle of the diaphragm 130. In the example of FIG. 1A, the air gap 120 is circular in shape, however, embodiments are not limited thereto. In some embodiments, the air gap 120 may be square in shape, rectangular in shape, or the like. Furthermore, the microphone 110 may be disposed inside the air gap 120. For example, an outer perimeter of the microphone 110 may be inside an inner perimeter of the hole in the diaphragm thereby creating the air gap 120 between the diaphragm and the microphone 110.

According to various embodiments, the diaphragm 130 may be disposed within a housing 140 that is securely affixed or otherwise attached to the diaphragm 130. In addition, the microphone 110 may also be securely affixed to the housing 140. The housing 140 may hold the diaphragm 130 and the microphone 110 in place such that the air gap 120 exists. Housing 140 may be used to position the diaphragm 130, the microphone 110, and the air gap 120 along a common plane. In this example, the housing may be part of a ceiling tile assembly and the front of the speakerphone apparatus may point downward/vertically from the ceiling. For example, a vertical plane may be defined by the XZ axes and may restrict the placement of the diaphragm 130, the microphone 110 and the air gap 120 along a common plane, which in the example of FIG. 1A is a vertical height along the Y axis as shown in the example of FIG. 1C. However, the common plane may also be a common horizontal plane, etc.

In this example, the location of the microphone 110 may be in a direction that is 90° with respect to the on-axis direction of the diaphragm 130. According to various embodiments, the location of the microphone 110 may be in an acoustic null area of the diaphragm 130. Here, the microphone 110 may be placed in an acoustic null area of the diaphragm 130 located along an interior of the diaphragm 130 and in a direction that is 90° relative to the on-axis direction of the diaphragm 130. The air gap 120 in between the microphone 110 and the diaphragm 130 may be used to position the microphone 110 within the acoustic null of the diaphragm 130. As a result, the sound radiation from the diaphragm 130 can be significantly reduced on the microphone 110.

In some embodiments, the speakerphone apparatus includes a square shape and may be integrated within the ceiling tile assembly. Although not shown in FIG. 1A, the housing 140 may include mechanisms for securing or otherwise affixing the housing 140 and its contents to the ceiling of a room, etc. In this example, the diaphragm 130 is configured to emit sound and the microphone 110 is configured to receive sound such as sound spoken during a teleconference.

In the example of FIG. 1A, the diaphragm 130 has a square shape but embodiments are not limited thereto. The square was chosen because it maximizes the surface area of the loudspeaker when used in a square ceiling tile area. The diaphragm/loudspeaker shape is otherwise arbitrary. As another example, the diaphragm shape may be a rectangle, a hexagon, a circle, or the like. The interior hole where the air gap 120 exists is shaped like a circle in the example of FIG. 1A, but it can also be other shapes and does not need to be a circle for the desired effect to exist. As another example, the interior hole may be a square, a rectangle, a hexagon, or the like.

FIG. 1B illustrates a rear-perspective view 100B of the speakerphone apparatus according to example embodiments. Referring to FIG. 1B, a back of the speakerphone apparatus shown in FIG. 1A is shown in FIG. 1B. Referring to FIG. 1B, a securing mechanism 150 may be affixed to the housing 140 (or otherwise part of the housing 140), and may also be affixed to the microphone 110 thereby holding the microphone 110 in place. As an example, the securing mechanism 150 may be a thin piece of wood, metal, etc. referred to as a slat, strap, band, binding, etc. Here, the example includes two securing mechanisms 150, however, there may be less securing mechanisms or more securing mechanisms.

FIG. 1C illustrates a side-perspective view 100C of the speakerphone apparatus shown in FIG. 1A, according to example embodiments. In this example, the view 100C includes a cutout of the speakerphone apparatus along a line 102 shown in FIG. 1A. Referring to FIG. 1C, the diaphragm 130 includes a first portion on a left-side of the drawing and a second portion on a right-side of the drawing. In between the first portion and the second portion of the diaphragm 130 is the microphone 110. Furthermore, the air gap 120 exists in between an inner perimeter 131 of the diaphragm 130 and an outer perimeter 111 of the microphone 110. Meanwhile, an exterior perimeter 132 of the diaphragm 130 is affixed or otherwise secured to the housing 140.

In this example, the diaphragm 130 may be secured to the housing 140, for example, using an adhesive, tape (foam tape), etc. For example, an exterior edge of the diaphragm 130 may be attached to the interior edge of the housing 140 using the adhesive, tape, etc. This ensures that the diaphragm 130 is not secured by a mechanism which touches the face of the diaphragm 130, because this would prevent the diaphragm 130 from vibrating freely. Rather, the diaphragm 130 is secured on it side walls using adhesive, tape, etc.

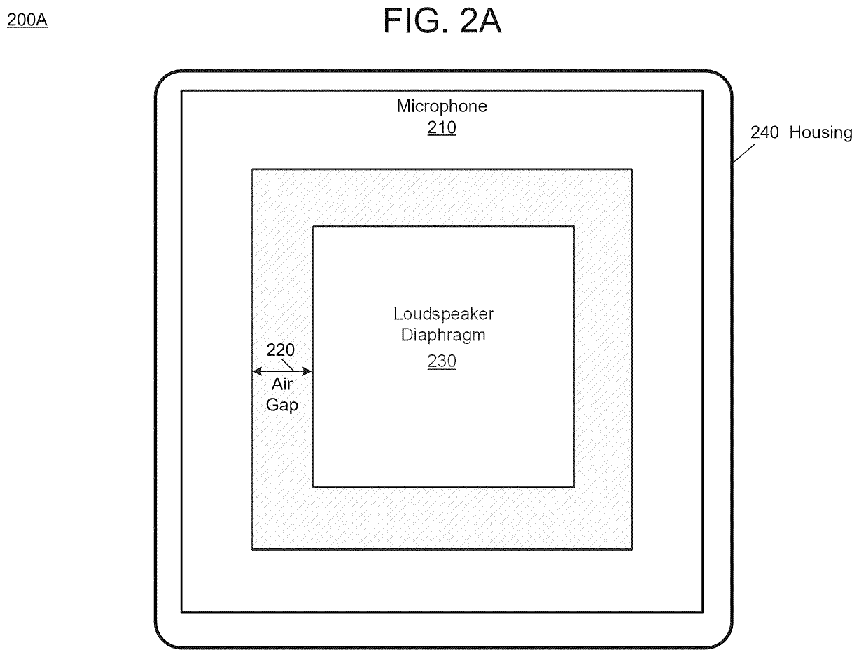

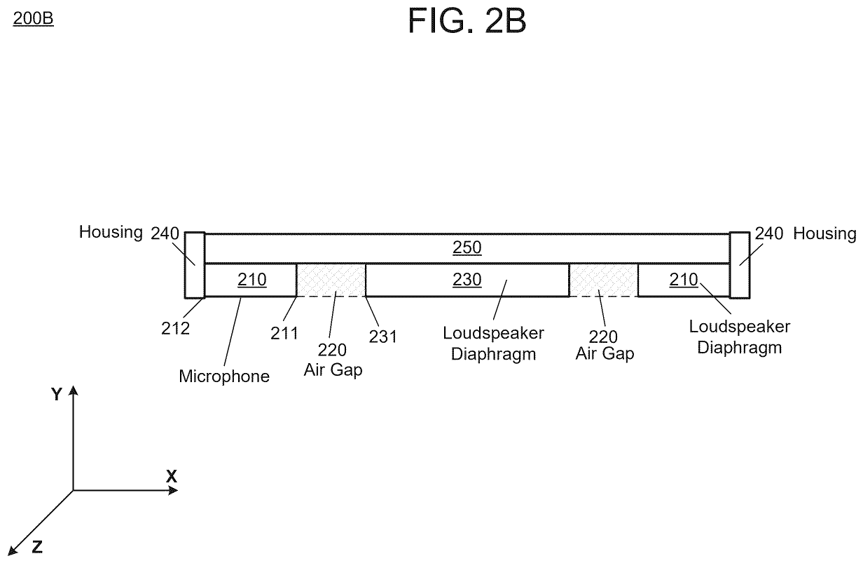

FIG. 2A illustrates a front-perspective view 200A of a speakerphone apparatus according to other example embodiments. Referring to FIG. 2A, the speakerphone apparatus includes a diaphragm 230 in a center thereof and a microphone 210 around an outside of the diaphragm 230. In FIGS. 1A-1C, the air gap is created by removing a center portion of the diaphragm and inserting a microphone therein. In contrast, in FIG. 2A, the microphone 210 is located around an exterior perimeter edge of the diaphragm 230. Here, an air gap 220 is created between the diaphragm 230 located on an interior of the speakerphone apparatus and the microphone 210 located on an exterior of the speakerphone apparatus.

The speakerphone apparatus in FIG. 2A also includes a housing 240 which is configured to hold the diaphragm 230 and the microphone 210 in place such that the air gap 220 is present and such that the diaphragm 230, the air gap 220, and the microphone 210 are arranged along a same/common plane.

In this example, the location of the microphone 210 may be in a direction that is 90° with respect to the on-axis direction of the diaphragm 230. According to various embodiments, the location of the microphone 210 may be in an acoustic null area of the diaphragm 230. By placing the microphone 210 along an exterior of the diaphragm 230, and with an air gap 220 in between the microphone 210 and the diaphragm 230 such that the microphone 210 is located in an acoustic null of the diaphragm 230, the sound radiation from the diaphragm 230 can be significantly reduced on the microphone 210.

FIG. 2B illustrates a side-perspective view 200B of the speakerphone apparatus shown in FIG. 2A, according to example embodiments. In this example, the view 200B includes a cutout view similar to the cutout view shown in FIG. 1C. In this example though, the microphone 210 includes a first portion on a left-side of the drawing and a second portion on a right-side of the drawing. In between the first portion and the second portion of the microphone 210 is the diaphragm 230. Furthermore, the air gap 220 exists in between an inner perimeter 211 of the microphone 210 and an outer perimeter 231 of the diaphragm. Meanwhile, an exterior perimeter 212 of the microphone 210 is affixed or otherwise secured to the housing 240. In addition, an attachment mechanism 250 is shown affixing the diaphragm 230, the microphone 210, and the housing 240 together. In some embodiments, the attachment mechanism 250 may attach to two of the components and not all three. For example, the attachment mechanism 250 may secure the diaphragm 230 to the housing 240, without being attached to the microphone 210. As another example, the attachment mechanism 250 might secure the microphone 210 to the housing 240, without being attached the diaphragm 230.

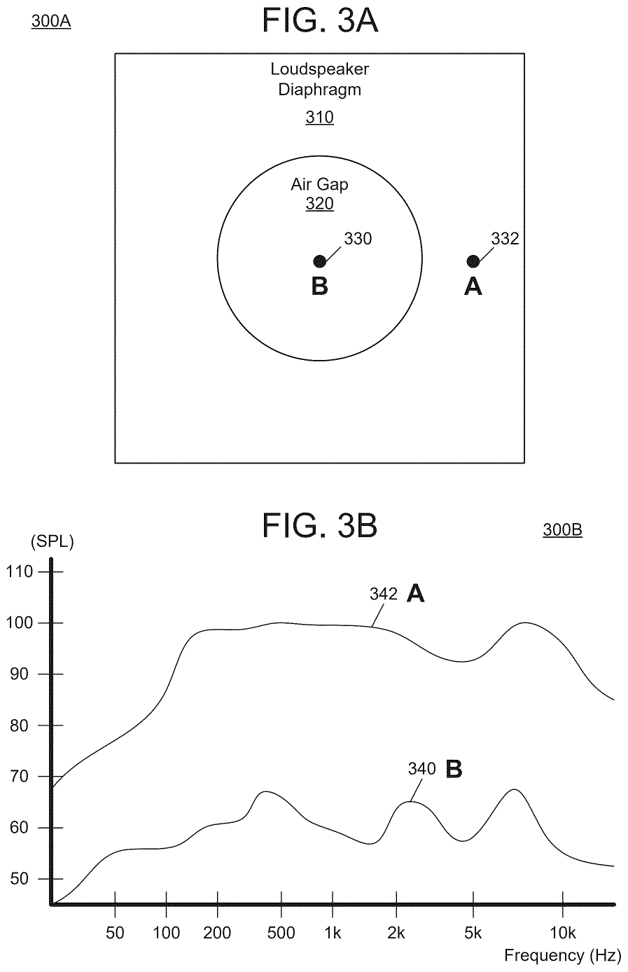

FIGS. 3A-3B illustrate sound pressure level (SPL) measurements at different points along the unified loudspeaker and microphone apparatus according to example embodiments. For example, FIG. 3A illustrates a view 300A of different locations on a speakerphone apparatus where sound pressure level measurements are taken. The speakerphone apparatus in FIG. 3A is similar to the speakerphone apparatus as shown in the examples of FIGS. 1A-1C. In this example, a diaphragm 310 includes a square shape and a hole in the middle creating an air gap 320. A microphone 330 is disposed inside the air gap 320. The sound pressure level from the diaphragm 310 can be measured at different locations including a location 332 within a center of the air gap 320 (and the microphone 330) and a location 334 which is near a center of the diaphragm 310.

FIG. 3B illustrates a graph 300B of the sound pressure level measurements taken at the location 332 within the center of the air gap 320 and the location 334 toward the center of the diaphragm 310. In particular, the SPL frequency response 342 corresponds to sound pressure level measurement at the location 332 when sound is emitted from the diaphragm 320, and the SPL frequency response 344 corresponds to sound pressure level measurement at the location 334 when the sound is emitted from the diaphragm 320. Here, it can be visualized that the SPL frequency response 340 at the center of the air gap 320 is significantly lower in level than the SPL frequency response 342 at the center of the diaphragm 320. This is due to the acoustic null created by the dipole directivity. In this example, a microphone disposed inside the air gap 320 will pick-up much less of the sound radiated by the loudspeaker diaphragm than in comparison to a microphone arranged at or near the center of the diaphragm 332.

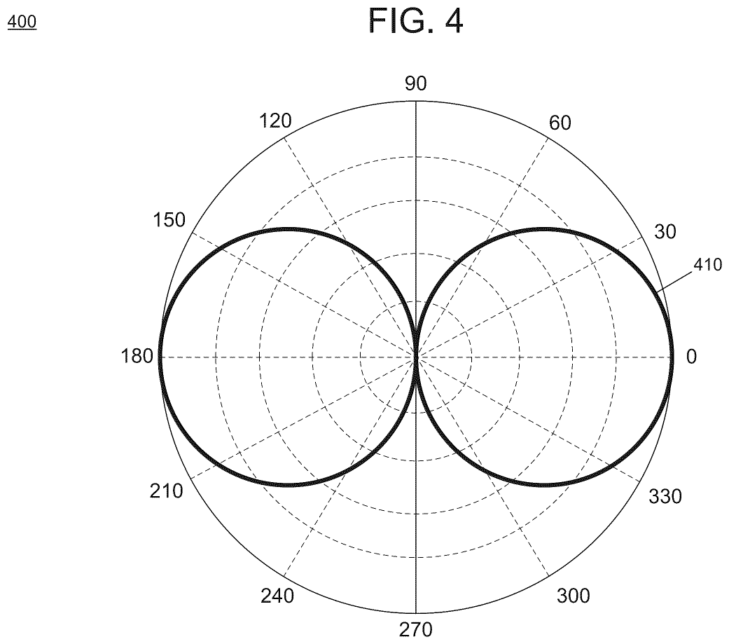

FIG. 4 illustrates a graph 400 of a dipole directivity sound radiation graph of a speakerphone apparatus according to example embodiments. Referring to FIG. 4, the directivity pattern 410 emitted from a diaphragm is shown, such as the diaphragm in any of the examples described herein with respect to FIGS. 1A-1C, 2A-2B, and 3A-3B. In this example, the on-axis direction, 0°, is normal (perpendicular) to the diaphragm emitting the sound in a frontward direction. The sound emitted in a rearward direction, 180°, is of an opposite polarity relative to the sound emitted in the frontward direction. Meanwhile, a null area exists along a plane that is 90° and 270° with respect to the on-axis direction (0°) normal to the diaphragm. By placing the microphone within this null plane, the sound from the loudspeaker diaphragm picked up by the microphone can be reduced.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order and/or with hardware elements in configurations that are different from those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only, and the scope of the application is to be defined solely by the appended claims when considered with a full range of equivalents and modifications (e.g., protocols, hardware devices, software platforms, etc.) thereto.

What is claimed is:

1. An apparatus comprising:
a housing;
a loudspeaker integrated into the housing;
a microphone integrated into the housing; and
an air gap disposed in between the loudspeaker and the microphone,
wherein the loudspeaker, the microphone, and the air gap are arranged along a common plane within the housing.

2. The apparatus of claim 1, wherein the housing comprises a ceiling tile.

3. The apparatus of claim 1, wherein the air gap is disposed inside an outer perimeter of the loudspeaker and the microphone is integrated into the air gap.

4. The apparatus of claim 3, wherein the loudspeaker comprises a square shape, and the air gap comprises a circular shape disposed inside an outer perimeter of the square shape of the loudspeaker.

5. The apparatus of claim 1, wherein the air gap is disposed outside of an outer perimeter of the loudspeaker and the microphone is integrated outside of the outer perimeter of the loudspeaker.

6. The apparatus of claim 1, wherein the air gap creates an acoustic null within the housing.

7. The apparatus of claim 1, further comprising a securing mechanism attached to at least two of the housing, the microphone, and the loudspeaker such that the air gap exists between the microphone and the loudspeaker.

8. The apparatus of claim 7, wherein the securing mechanism comprises at least one slat that is attached to the microphone and to the loudspeaker.

9. The apparatus of claim 1, wherein the loudspeaker comprises a distributed mode loudspeaker (DML) which produces sound by an exciter inducing distributed vibration modes with a diaphragm.

10. An apparatus comprising:
a substrate;
a loudspeaker integrated into the substrate;
an air gap inside an outer perimeter of the substrate; and
a microphone disposed inside the air gap.

11. The apparatus of claim 10, wherein the loudspeaker, the air gap, and the microphone are arranged along a common plane in the substrate.

12. The apparatus of claim 10, wherein the substrate comprises a ceiling tile.

13. The apparatus of claim 10, wherein the loudspeaker comprises a square shape, and the air gap comprises a circular shape disposed inside an outer perimeter of the square shape of the loudspeaker.

14. The apparatus of claim 10, wherein an acoustic null of the loudspeaker radiation is created by the air gap within the substrate.

15. The apparatus of claim 10, further comprising a securing mechanism attached to at least two of the substrate, the loudspeaker, and the microphone, such that the air gap exists between the microphone and the loudspeaker.

16. The apparatus of claim 15, wherein the securing mechanism comprises at least one slat that is attached to the microphone and to the loudspeaker.

17. The apparatus of claim 10, wherein the loudspeaker comprises a distributed mode loudspeaker (DML) which produces sound by an exciter inducing distributed vibration modes in a diaphragm.

18. An apparatus comprising:
a substrate;
a microphone integrated into the substrate;
a loudspeaker integrated into the substrate and inside of the microphone; and
an air gap disposed between an outer perimeter of the loudspeaker and an inner perimeter of the microphone.
